(19) United States
(12) Patent Application Publication
(10) Pub. No.: US 2025/0338100 A1
(43) Pub. Date: Oct. 30, 2025

(54) METHOD AND SYSTEM FOR PROVIDING MULTI SIM MULTI ACTIVE FUNCTIONALITY

(71) Applicant: Harman Becker Automotive Systems GmbH, Karlsbad-Ittersbach (DE)

(72) Inventors: Gerhard Grossberger, Ulm (DE); Ralph Harry Goeckelmann, Dornstadt (DE); Klaus Riess, Riemerling (DE)

(21) Appl. No.: 19/110,787

(22) PCT Filed: Sep. 14, 2022
(86) PCT No.: PCT/EP2022/075572

§ 371 Date: Mar. 11, 2025

(51) Int. Cl. H04W 4/60; H04W 4/44; H04W 4/80; H04W 76/10

(52) U.S. Cl. CPC H04W 4/60; H04W 4/44; H04W 4/80; H04W 76/10

(57) ABSTRACT

The disclosure relates to a method and system for providing Multi SIM Multi Active, MSMA, functionality to an electronic control unit, ECU. The MSMA device comprises a housing, comprising at least one wireless network access device, NAD, at least one antenna and an interface configured to communicatively couple the NAD to at least one external ECU, in particular an ECU of a vehicle, to provide at least one additional independent network access channel for the ECU.

### FIELD

The present disclosure relates to the field of telematics, in particular to Multi SIM Multi Active functionality for data communication.

### BACKGROUND

Advances in the field of connected cars and autonomous driving vehicles involve including telematics control units (TCUs) into on-board systems of such vehicles. A TCU is an embedded wireless system which enables connecting a vehicle to cloud services or other vehicles over a cellular network, e.g. using V2X standards. The TCU may collect data such as vehicle speed, position, engine data and the like from various sub-systems in the vehicle. The TCU may also enable in-vehicle connectivity using Wifi and Bluetooth.

Multi SIM Multi Active (MSMA) is a cellular communications feature that allows a plurality of separate and independent communication channels to operate at the same time. In the context of the automotive industry, MSMA enables e.g. dividing original equipment manufacturer (OEM) data from consumer data consumptions and data plans.

A common implementation for providing Dual SIM Dual Active (DSDA) functionality to existing TCUs is to use two network access devices (NADs), e.g. wireless modems, inside of one telematics control unit. However, in this approach, the existing TCU hardware and software must be adjusted to support the DSDA functionality bringing the need for further development and repeated certification. Thus, this approach offers only an individualized solution for respective existing TCU architectures and embedding environments and is expensive to implement.

Thus, there is a need to improve the implementation of MSMA functionality to existing TCU system architectures.

### SUMMARY

A first aspect of the invention relates to a Multi SIM Multi Active, MSMA, device. The MSMA device includes a housing, comprising at least one wireless network access device, NAD, at least one antenna and an interface configured to communicatively couple the NAD to at least one external electronic control unit, ECU, in particular an ECU of a vehicle, to provide at least one additional independent network access channel for the ECU.

The MSMA device may, for example, be a dual SIM dual active, DSDA, device. The device may be a portable add-on module and attachable and connectable to existing ECUs, such as TCUs. The ECU provides a first NAD while the MSMA device provides at least one additional NAD. In sum, this enables MSMA functionality.

The network access channel provided by the MSMA device and the network access channel provided by the ECU may operate independently from each other. Thereby, they enable independent communication at the same time.

Further, the MSMA device may include at least one antenna, thereby offering a space saving solution.

The MSMA device maybe pre-developed and certified for use prior to installation and attachment to an existing ECU. In other words, the MSMA device may be developed and certified once instead of being an individual solution for adding MSMA functionality to existing ECUs, which need to be tailored to the preexisting conditions and certified individually.

Further, no physical changes need to be performed on the existing ECU to enable MSMA functionality, as the add-on MSMA device may allow for fast and easy installation and a cost effective, fast and efficient implementation to ECUs.

The configuration of the MSMA device as an add-on to standard ECUs allows for dividing function of the NADs. For example, one NAD may be assigned to communications related to autonomous driving, while another NAD may be assigned to communications related to infotainment.

In an embodiment, the ECU provides a first network access channel. The first network access channel may be provided by a NAD included in the ECU. Thereby, the existing configuration of an existing ECU may be used and combined with the MSMA device to provide MSMA functionality, thereby providing an efficient, in particular cost effective, realization of the MSMA functionality.

In another embodiment, a first network access channel provided by the ECU, and the at least one additional independent network access channels are configured to provide communication with either original equipment manufacturer, OEM, data or consumer data exclusively. In other words, the access to OEM and consumer data is divided. Thereby, a sufficient communication resources for critical OEM data are ensured. Further, data streams for OEM and consumer generated data may be split and individually analyzed.

According to another embodiment, the at least one additional independent network access channel provides cellular connectivity, thereby enabling wireless communication and connectivity to other ECUs, cloud services, and the like.

In another embodiment, the interface comprises a wired, in particular Ethernet, interface. Hence, the MSMA device has a high grade of portability and may be positioned in a cost-and space-saving manner. Further, a high data throughput, such as 5G enabled data throughput, to the MSMA device may be enabled.

In an embodiment, the MSMA device is a portable device that is preferably detachably coupled to the vehicle and/or the ECU. Thereby, fast and easy installation of the add-on MSMA device is enabled. Further, the MSMA device thereby provides a space-and weight-saving solution to add MSMA functionality to existing ECUs.

In another embodiment, the MSMA further comprises a processor and a computer-readable medium comprising instructions which, when executed by the processor, cause the device to control communication between the NAD and the external ECU. In particular, the communication may be controlled using a software development kit, SDK, and an application programming interface, API. In other words, a control software is included in the MSMA device completing the add-on module. The SDK and API may be compatible with the existing ECU. Thereby, efficient control of the MSMA functionality is provided. Including the processor and computer-readable medium in the MSMA device further enables high compatibility with the external ECU and enables installation and implementation of the MSMA device without the necessity to perform any modification to the existing ECU.

According to another embodiment, the processor or the SDK and the API are configured to integrate the at least one additional network access channel into an in-vehicle infotainment, IVI, system. Thereby, pre-existing communication structures may be used rendering the add-on MSMA device compatible with the external ECU and thus more efficient.

In an embodiment, the at least one antenna includes at least one integrated and/or external antenna. Thereby, the design or form factor of the MSMA device may be improved with respect to space and functionality. Including antennas to the MSMA device has the advantage of saving space as well as costs for cables and connectors.

In an embodiment the MSMA device further comprises a WiFi-Module, e.g. included in the NAD, configured to provide Wireless Local Area Network (WLAN) access to the at least one additional independent network access channel.

In that manner, the MSMA device may act as a router between the additional network access channel, such as a 5G network access channel, and additional devices, such as a the ECU or a client device (e.g. driver portable device). The MSMA may thus directly provide a hotspot for using the additional network access, e.g. for accessing a 5G network, in particular without connecting to (other) ECUs.

A second aspect of the invention relates to a method for providing Multi SIM Multi Active, MSMA, functionality. The method comprises establishing communication between the MSMA device as described above, and an engine control unit, ECU and managing the communication via an interface. The communication may for example be established by the MSMA and/or by the ECU. The established communication may be managed by the MSMA and/or by the ECU.

The interface may be an application programming interface. Thereby, the add-on MSMA device may be implemented to an existing ECU without the necessity of amending the ECU. In contrast, the MSMA device includes its own interface to provide connectivity to the ECU and to manage the communication with the ECU.

In an embodiment, the ECU is a telematics control unit, TCU. Thereby, wireless connectivity between, for example, a vehicle including the TCU and a cloud service is enabled.

According to another embodiment, the method further comprises assigning original equipment manufacturer, OEM, data and consumer data each to a respective, in particular different, one of the network access device, NAD, of the MSMA device and an external NAD included in the ECU. Again, this step may be performed by the MSMA and/or by the ECU. Thereby, a sufficient communication resources for OEM data are ensured. Further, data for OEM and consumer generated data may be split and analyzed individually. Thereby, for example, costs may be split.

A third aspect of the invention relates to a computer program product comprising a computer-readable storage medium including instructions that, when executed by a processor, cause the processor to perform the method described above. All properties of the method of the present disclosure also apply to the computer program product.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 depicts a block diagram of a system including an MSMA device according to one or more embodiments and a ECU communicatively coupled to the MSMA;

FIG. 2 depicts a flow chart of a method for providing MSMA functionality according to one or more embodiments.

### DETAILED DESCRIPTION OF THE PREFERRED EMBODIMENTS

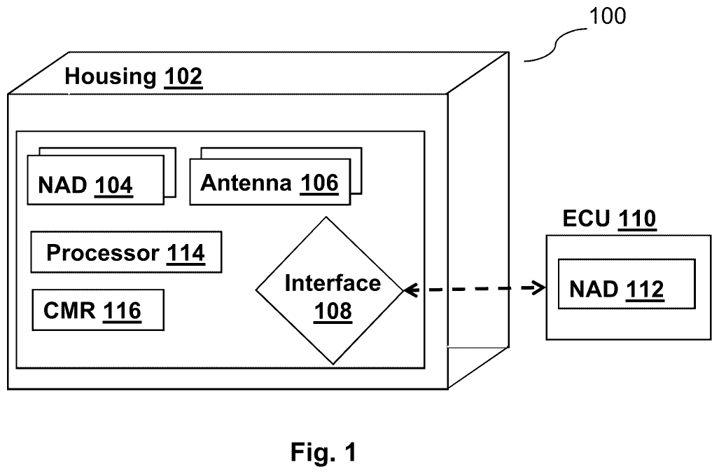

Figure 1 depicts a block diagram of a Multi SIM Multi Active, MSMA, device 100. The MSMA device 100 comprises a housing 102 which includes at least one network access device, NAD, 104, at least one antenna 106, an interface 108, a processor 114 and a computer readable medium, CRM, 116. The MSMA device 100 further requires power supply.

The MSMA device 100 provides MSMA functionality to the external ECU 110. The ECU 110 may, preferably, be a telematics control unit, TCU, of a vehicle, such as a car. The external ECU 110 provides a first network access channel using a NAD 112 of the ECU 110. The first network access channel is compatible with the MSMA device. The NAD 104 of the MSMA device 100 provides at least one additional network access channel. The one or more network access channels provided by the one or more NADs 104 and the first network access channel provided by the NAD 112 of the ECU 100 operate independently from each other. For example, the MSMA device 100 may comprise one additional NAD 104, thereby providing Dual SIM Dual Active, DSDA, functionality. In this case, the MSMA device 100 is a DSDA device. For example, the NAD 112 of the ECU 110 may exclusively provide communication of OEM data and the NAD 104 of the MSMA device 100 may exclusively provide communication of consumer data, or vice versa.

The MSMA device 100 is a portable device. The housing 102 is configured to be detachably coupled to a vehicle, e.g. a car and/or to an external electronics control unit, ECU, 110. The MSMA device may be implemented anywhere at the vehicle, e.g. at the car, no metallic shielding provided. The design of the MSMA device, in particular the design of the housing of the MSMA device, may follow the outline of the vehicle, in particular the car.

The NAD 104 and/or NAD 114 may be a wireless modem. The NAD 104 provides an additional independent network access channel. This channel preferably provides cellular connectivity.

The interface 108 comprises a wired interface, preferably an Ethernet interface. The interface 108 may further comprise an interface to computing devices of the vehicle. The interface 108 may comprise a user interface displayed at a screen of the vehicle, e.g. a screen used for in-vehicle infotainment. The interface communicatively couples the MSMA device 100, in particular the NAD 104 of the MSMA device 100, to the ECU 110.

The antenna 106 may be included in a transceiver. The at least one antenna 106 may include integrated antennas and, alternatively or additionally, external antennas. In particular, the MSMA device 100 may be designed like a Harman “Conformal Smart Antenna” without any shark-fin.

The MSMA device 100 includes the processor 114 and the CRM 116. The processor 114 may be an application processor. The CRM 116 has instructions stored thereon, which cause the MSMA device 100 to control the communication between the NAD 104 and the ECU 110. The processor 114 may thereby integrate the additional network access channel provided by NAD 104 into an in-vehicle infotainment system.

The MSMA device 100 is controlled using a software development kit, SDK, and an application programming interface, API. The SDK enables any ECU 110 to establish communication to the MSMA device 100. The SDK manages the MSMA device 100 via the API. The SDK may also manage other functions of the MSMA device 100, such as the power supply. The SDK and API may be configured to integrate the additional network access channel provided by NAD 104 into an in-vehicle infotainment system. For example, the SDK may enable the implementation of an additional App.

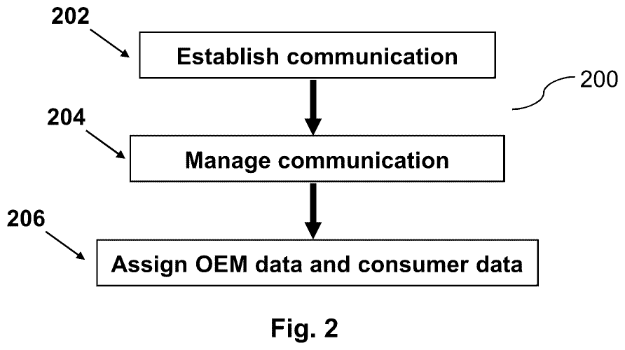

FIG. 2 describes a method 200 for providing MSMA functionality. In step 202, a communication between the MSMA device 100 and the ECU 110 is established. This may be enabled by the interface 108 and a software development kit. For example, the communication may be established via a wired connection, in particular an Ethernet connection. In step 204, the communication between the MSMA device and the ECU is managed via the interface 108. In step 206, OEM data and consumer data are assigned to one of the NADs 104 or 114, respectively. For example, OEM data may be assigned to the NAD 104 of the MSMA device 100 and consumer data may be assigned to the NAD 112 of the ECU 110, or vice versa. The so assigned data are then processed using either NAD 104 or 112.

### REFERENCE SIGNS

100 Multi SIM Multi Active, MSMA, device
102 Housing
104 Network access device, NAD
106 Antenna
108 Interface
110 Electronic control unit, ECU
112 NAD of ECU
114 Processor
116 Computer readable medium
200 Method for providing MSMA functionality
202-206 Steps of method 200

1. A Multi SIM Multi Active, MSMA, device comprising:
a housing, comprising:
at least one wireless network access device, NAD;
at least one antenna; and
an interface configured to communicatively couple the NAD to at least one external electronic control unit, ECU to provide at least one additional independent network access channel for the ECU.

2. The MSMA device of claim 1, wherein the ECU provides a first network access channel, and wherein the ECU is a vehicle ECU.

3. The MSMA device of claim 2, wherein a first network access channel provided by the ECU, and the at least one additional independent network access channels are configured to provide communication with either original equipment manufacturer, OEM, data or consumer data exclusively.

4. The MSMA device of claim 2, wherein the at least one additional independent network access channel provides cellular connectivity.

5. The MSMA device of claim 2, wherein the interface comprises a wired interface.

6. The MSMA device of claim 2, wherein the MSMA device is a portable device that is preferably detachably coupled to the vehicle and/or the ECU.

7. The MSMA device of claim 2 further comprising a processor and a computer-readable medium comprising instructions which, when executed by the processor, cause the device to control communication between the NAD and the external ECU.

8. The MSMA device of claim 7, wherein the MSMA device is controlled using a software development kit, SDK, and an application programming interface, API.

9. The MSMA device of claim 8, wherein the processor or the SDK and the API are configured to integrate the at least one additional network access channel into an in-vehicle infotainment, IVI, system.

10. The MSMA device of claim 2, wherein the at least one antenna includes at least one integrated and/or external antenna.

11. The MSMA device of claim 2, further comprising a WiFi-Module, included in the NAD, configured to provide Wireless Local Area Network, WLAN, access to the at least one additional independent network access channel.

12. A method for providing Multi SIM Multi Active, MSMA, functionality, the method comprising:
establishing communication between the MSMA device of claim 1, and an engine control unit, ECU; and
managing the communication via an interface.

13. The method of claim 12, wherein the ECU is a telematics control unit, TCU.

14. The method of claim 12, further comprising assigning original equipment manufacturer, OEM, data and consumer data each to a respective, different, one of the network access device, NAD, of the MSMA device and an external NAD included in the ECU.

15. (canceled)

16. The method of claim 14, wherein the ECU provides a first network access channel, and wherein the ECU is a vehicle ECU.

17. The method of claim 16, wherein a first network access channel provided by the ECU, and the at least one additional independent network access channels are configured to provide communication with either original equipment manufacturer, OEM, data or consumer data exclusively.
